(19) United States
(12) Patent Application Publication
(10) Pub. No.: US 2011/0249743 A1
(43) Pub. Date: Oct. 13, 2011

(54) Super-block for high performance video coding

(76) Inventors: Jie Zhao, Camas, WA (US); Christopher A. Segall, Camas, WA (US)

(21) Appl. No.: 12/798,708

(22) Filed: Apr. 9, 2010

(51) Int. Cl. H04N 7/30; H04N 7/26

(52) U.S. Cl. 375/240.16; 375/240.24; 375/E07.124; 375/E07.226

(57) ABSTRACT

A system for encoding and/or decoding video that includes the use of super blocks. The use of super blocks permits a reduction in the bit-rate of the video bit stream.

### CROSS-REFERENCE TO RELATED APPLICATIONS

Not applicable.

### BACKGROUND OF THE INVENTION

The present invention relates generally to a video encoder and/or a video decoder.

The transmission of video across a network typically includes a video encoder and a video decoder. The encoding of the video includes a lossy compression technique to achieve a lower bit rate for transmission while still providing a perceptually good video quality. By way of example, digital video discs used a MPEG-2 video compression standard, hereby incorporated by reference in its entirety.

Video compression typically operates based upon the grouping of neighboring pixels together, generally referred to as macroblocks. A macroblock, or other group of pixels, are compared from one frame to another frame, where the differences between the frames are transmitted. In the presence of motion, the video compression transmits data indicative of the motion of the macroblock, or other group of pixels, from one frame to another frame together with the differences between the frames.

H.264/AVC (formally known as ISO/IEC 14496-10-MPEG-4 Part 10, Advanced Video Coding) video compression standard, hereby incorporated by reference herein in its entirety, is used for many applications, such as Blu-ray discs. The H.264 standard is a block based compression standard that typically results in good video quality at substantially lower bit rates than MPEG-2.

While the H.264 standard provides a good result there is a desire for ever increasing reduction in the bit rate, especially for high definition content, while not significantly decreasing the perceived image quality.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a video encoder.

FIG. 2 illustrates a video decoder.

FIG. 3 illustrates block encoding.

FIG. 4 illustrates mapping of super blocks.

FIGS. 5A and 5B illustrates syntax for slice data processing.

FIGS. 6A and 6B illustrates syntax for macroblock processing.

FIG. 7 illustrates extract, copy, and save for super-blocks.

### DETAILED DESCRIPTION OF PREFERRED EMBODIMENT

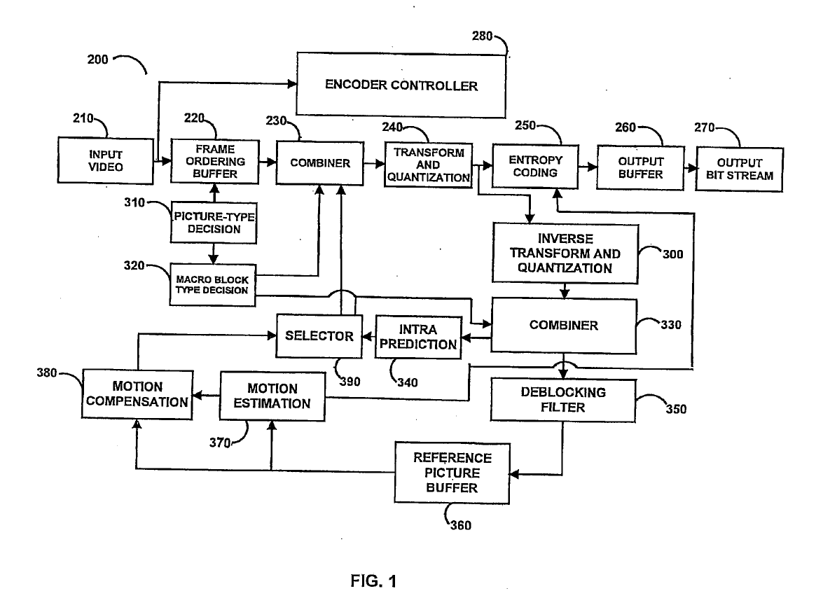

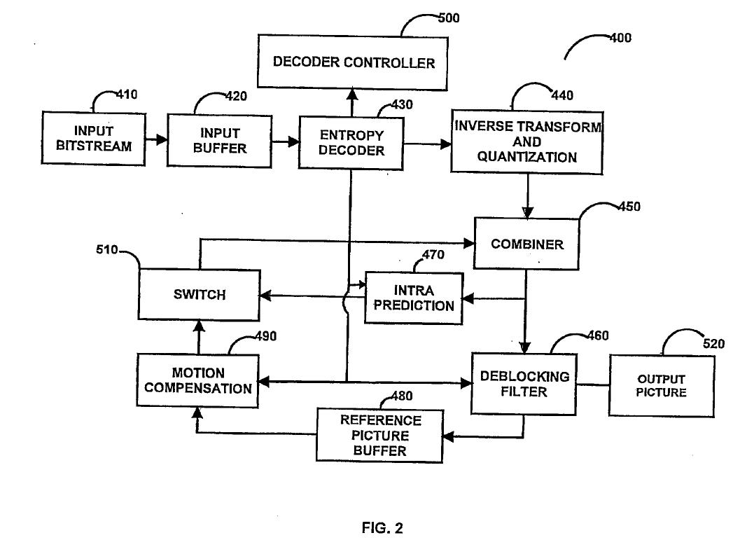

Referring to FIG. 1, an exemplary H.264 encoder 200 is described for purposes of illustration. It is to be understood that any video encoder may be used. The input video 210 is provided to a buffer suitable to reorder frames, or portions thereof, as necessary 220. A combiner 230 modifies a portion of the suitable reordered frame in a manner suitable for a transform and quantization process 240. The transform and quantization process 240 provides a signal to an entropy coder 250. The entropy coder 250 provides a signal to an output buffer 260 for the output bit stream 270. An encoder controller 280 that receives the input video 210 provides control signals to all the modules of the encoder 200.

The transform and quantization process 240 also provides its output to an inverse transform and quantization 300 so that the corresponding decoder can be simulated. A picture-type decision process 310 is interconnected with the frame ordering buffer 220. The picture-type decision process 310 is also interconnected to a macro-block-type decision 320. In this manner, control over the frame ordering buffer 220 may be achieved. In addition, control over the type of macro-block may be achieved.

The inverse transform and quantization 300 provides a signal to a combiner 330, which in combination with the macro-block type decision 320, provides a signal to an intra coding prediction module 340 and a deblocking filter 350. The deblocking filter 360 is interconnected to a reference picture buffer 360. The reference picture buffer 360 provides a signal to a motion estimation process 370 and a motion compensation process 380. The motion estimation 370 provides a signal to the motion compensation 380 and to the entropy coder 250. A selector 390 selects between the output of the motion compensation 380 and the output of the intra-coded prediction 340 for the combiner 230. In this manner, the combiner 230 receives information related to whether the macro-block is intra coded 340 or motion-compensation coded 380.

The decision made by the selector 390 relates to the macro-block type decision 320. For example, if the macro-block type decision 320 decides that the macro-block should be intra-coded, then the selector should select a form of intra-prediction. For example, if the macro-block type decision 320 decides that the macro-block should be motion compensated, then the selector should select a form of motion compensation. The decisions made by the macro-block type decision 320, the picture-type decision 310, the selector 390, and the selection among one or more intra-prediction techniques 340, are all included within the bit-stream by the entropy coding 250. In addition, the combiner 330 may receive an input from the selector 390 to provide information about the selection made.

Any suitable decoder may be used. An exemplary video decoder 400 for an input bit stream 410 includes an input buffer 420. The input buffer 420 provides a signal to an entropy decoder 430. The entropy decoder 430 provides a signal to an inverse transform and quantization process 440. The inverse transform and quantization process 440 provides a signal to a combiner 450. The combiner 450 provides a signal to a deblocking filter 460 and an intra-prediction module 470. The deblocking filter 460 provides a signal to a reference picture buffer 480. The reference picture buffer 480 provides a signal to a motion compensator 490.

The entropy decoder 430 provides a signal to the motion compensation 490 and the deblocking filter 460. The entropy decoder 430 also provides a signal to a decoder controller 500. The decoder controller is interconnected with the other modules of the decoder 400. The motion compensator 490 provides a signal to a switch 510. The intra-prediction module 470 provides a signal to the switch 510. The switch 510 selectively provides a signal to the combiner 450. The deblocking filter 460 provides an output picture 520.

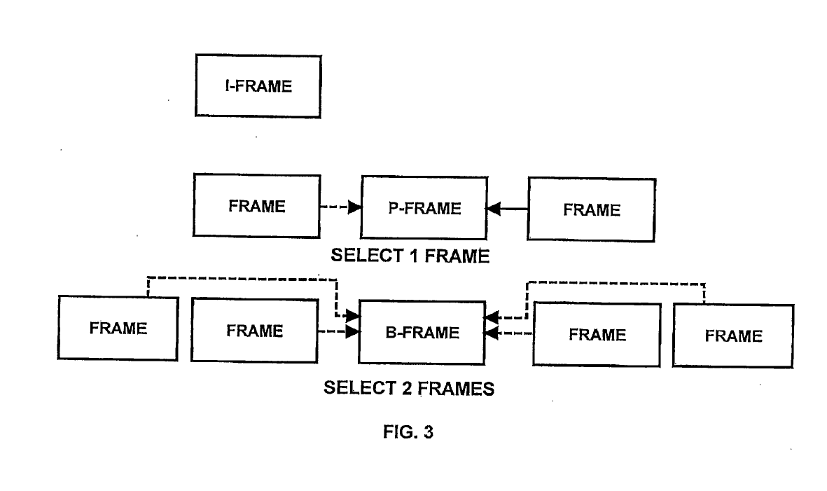

Referring to FIG. 3, different frames, or portions thereof, of video are typically encoded using different techniques. One such technique includes the use of picture types generally referred to as I-frames, P-frames, and B-frames. I-frames do not require other video frames to decode. P-frames may use data from a previously transmitted frame to decode. B-frames may use two or more previously transmitted frames to decode. The encoding of the video may likewise be based upon one or more different sized blocks of pixels from within the frame. Also, the encoding of the video may likewise be based upon motion estimation, slices, spatial prediction of blocks, or otherwise between one or more frames. Therefore, in general there is decoder prediction information transmitted with the video bitstream which indicates the type of encoding of the frames, the type of prediction of the frames, the direction(s) of the predictions, which frames are used, motion estimation information between the frames, frame size information, block sizing information within the frame, spatial prediction information, and/or other suitable parameters. Accordingly, the decoder 400 decodes the frames of the video based upon the prediction information provided with the bit-stream by the encoder 200.

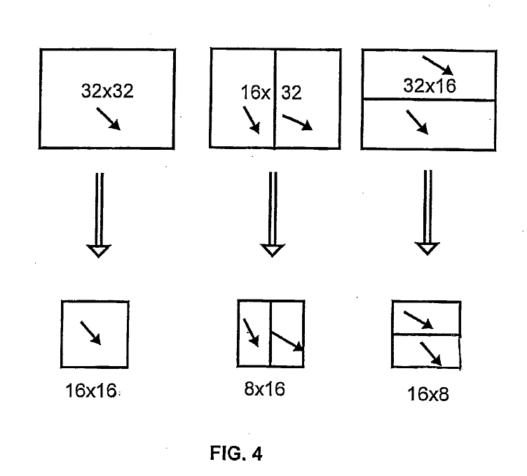

Referring to FIG. 4, in existing video coding systems, such as ITU-T H.264 or MPEG-4 AVC, a macro-block (MB) refers specifically to a 16×16 block of pixels. In different video coding systems it is desirable to support the 16×16 macro-block structure of such video coding systems while simultaneously supporting a “super-block” that refers to a group of N×N such 16×16 macroblocks, where N>=2. For the case that N=2, the super-block would define a 32×32 block of pixels. For example, in the case that N=4, the super-block defines a 64×64 block of pixels. The use of common information structure permits effective coding of macro-blocks and super-blocks.

In any exemplary implementation macro-blocks are generally considered to be partitions of super-blocks, just as blocks of 4×4 pixels are generally considered to be partitions of macro-blocks. As such, the four macro-blocks within a super-block may have common characteristics, such as a macro-block type, a transform type, and motion vectors. The video encoder encodes the common characteristics that are contained within a super-block. The video decoder decodes the common characteristics that are contained within a super-block.

To support the super-block at both the encoder and the decoder, images may be divided into super-blocks and processed in a 2×2 macro-block group order. The intra prediction mode, the motion vectors, the reference indices, and/or the mode decision consistent with macro-blocks may be included with the super-block type. For intra super-block encoding, the macro-block within a super-block type may be restricted to have the same macro-block type and/or the same prediction modes as the super-block. By way of example, macro-block types may include intra-coded 4×4, intra-coded 8×8, intra-coded 16×8, intra-coded 8×16, and/or intra-coded 16×16. For an inter-coded super-block, a partition of 32×32 may be used, two partitions of 32×16 may be used, and/or two partitions of 16×32 may be used. In addition, a super-block based skip mode may be used and a super-block based direct mode may be used. This super-block description is for N=2, while other values of N will have additional and larger partitions. Macro-blocks within the same partition preferably have same motion vectors and references indices. A “super-block flag” may be included within the bit-stream indicating whether a particular group of macro-blocks is a super-block or not. If so, an alternative syntax decoding process may be employed as described below. The super-block flag may also be used to control the transform size and which transform (or transforms) should be used.

Improved coding efficiency using a system that includes super-blocks primarily results from two aspects. The first aspect is that the system is capable of providing improved prediction. The second aspect is that the system has a reduction in the syntax necessary to describe a bit-stream. In particular, a significant portion of the super-block system based coding efficiency is the result of a reduction in the syntax signaling.

There are two primary functions that enable the efficient signaling of the super-block. The first function is a flag indicating a super-block and a flag indicating a particular super-block coded block pattern (hereinafter CBP). For each group of macro-blocks, a super-block flag is sent to indicate if the group should be decoded with the alternative, super-block process. If the flag is equal to 1 (or other value), then a super-block CBP flag is additionally sent to indicate whether the super-block has a residual.

The second function is the embedding of super-block information into a first macro-block (or a selected macro-block) of a group of corresponding macro-blocks of the super-block. In ITU-T H.264 and MPEG-4 AVC, macro-block type and other high level information is sent for each macro-block. For the super-block, the system reduces this signaling overhead by mapping super-block information into a macro-block and only transmitting the macro-block header for the first (or selected) macro-block. The macro-block type, motion vector difference (hereinafter referred to as MVD), and reference indices of a super-block are compacted and mapped to a 16×16 macro-block, and transmitted at the start of the first macro-block of the super-block. An exemplary mapping is illustrated in FIG. 4, where the arrows represent MVD for that partition. For example, a 32×16 super-block is mapped to a 16×8 macro-block, and the super-block information is sent as a 16×8 macro block. At the decoder, the mapping is reversed and the 16×8 macro-block is converted to a 32×16 super-block for reconstruction. Reference indices and reconstructed motion vectors are filled to corresponding macro-blocks within the super-block.

Macro-blocks within a super-block may share additional common characteristics, including macro-block skip, transform size, and delta quantization. This common information is also only sent with the first (or selected) macro-block within a super-block. For the non-first macro-blocks within a super-block, macro-block skip, transform size, delta-quantization, etc., are copied from the other macro-block.

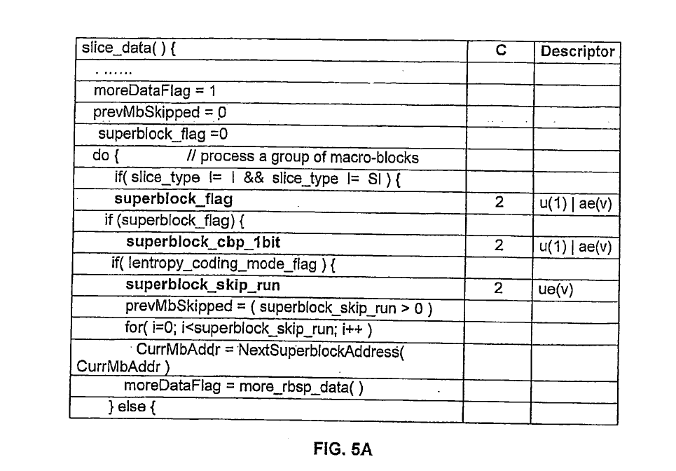

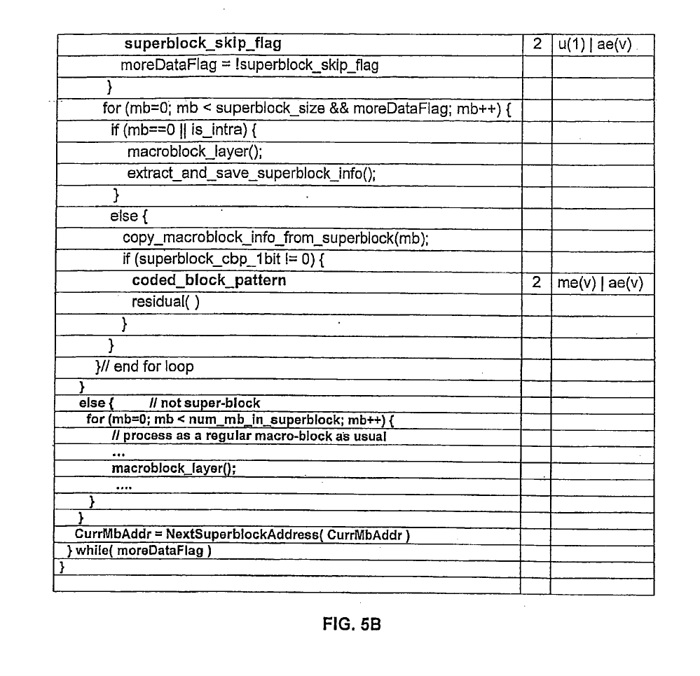

The suitable use of super-blocks result in a bit rate savings for signaling macro-block information. Detailed exemplary syntaxes are illustrated in FIGS. 5A and 5B. The syntaxes are based upon the syntaxes of slice_data in ITU-T H.264 and MPEG-4 AVC but are modified to process macro-block in a group of macro-blocks order. In FIGS. 5A and 5B, some common syntaxes such as slice_data in H.264/AVC are omitted for purposes of clarity. The additional syntax includes slice data semantics.

A superblock_flag specifies whether this group of macro-blocks is a super-block or not.

The superblock_cbp_{—}1 bit specifies whether this super-block has any coefficients. If superblock_cbp_{—}1 bit equals 1 means at least 1 macro-block within the superblock has coefficients. If superblock_cbp_{—}1 bit equals 0 means that none of the macro-blocks within the superblock has coefficients.

The superblock_skip_run specifies the number of consecutive skipped super-blocks for which, when decoding a P or SP slice, mb_type of macro-blocks within the super-block may be inferred to be P_Skip and the macro-block type is collectively referred to as P macro-block type, or for which, when decoding a B slice, mb_type may be inferred to be B_Skip and the macro-block type is collectively referred to as B macro-block type. The value of superblock_skip_run may be in the range of 0 to PicSizeInSuperblocks—Curr MbAddr, inclusive.

If superblock_skip_flag is equal to 1 specifies that for the current super-block, when decoding a P or SP slice, mb_type of macro-blocks within the super-block may be inferred to be P_Skip and the macro-block type is collectively referred to as P macro-block type, or for which, when decoding a B slice, mb_type may be inferred to be B_Skip and the macro-block type is collectively referred to as B macro-block type. If superblock_skip_flag equal to 0 specifies that the current super-block is not skipped.

The variable superblock_size denotes the number of macro-blocks in the super-block. For example, for a 32×32 super-block, the superblock_size is 4 except at the picture boundary where it may not be a multiple of 32.

The extract_and_save_superblock_info ( ) and copy_macroblock_info_from_superblock ( ) refer to functions to get the super-block syntaxes, save, and fill them into the macro-blocks.

The nextSuperblockAddress ( ) returns the start macro-block address of the next super-block.

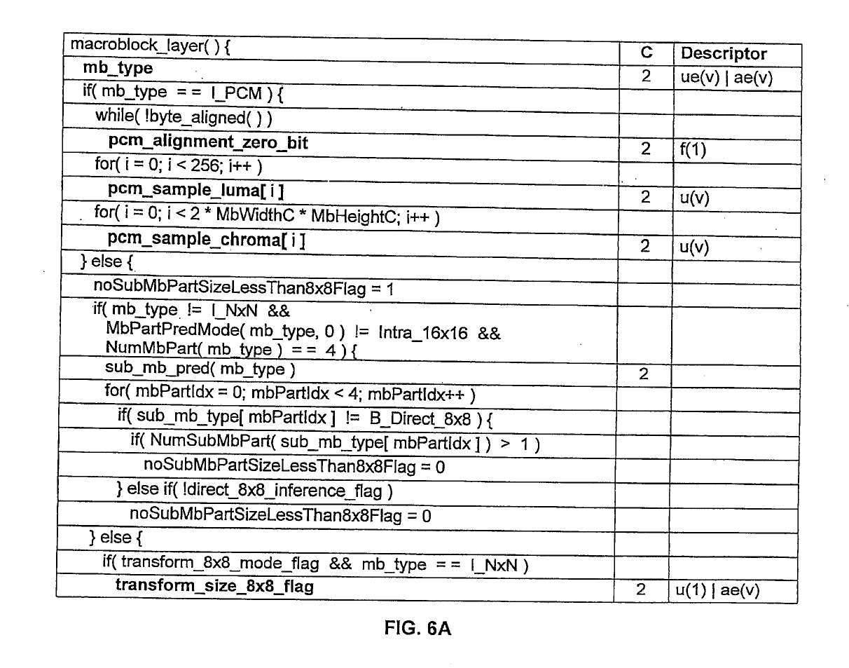

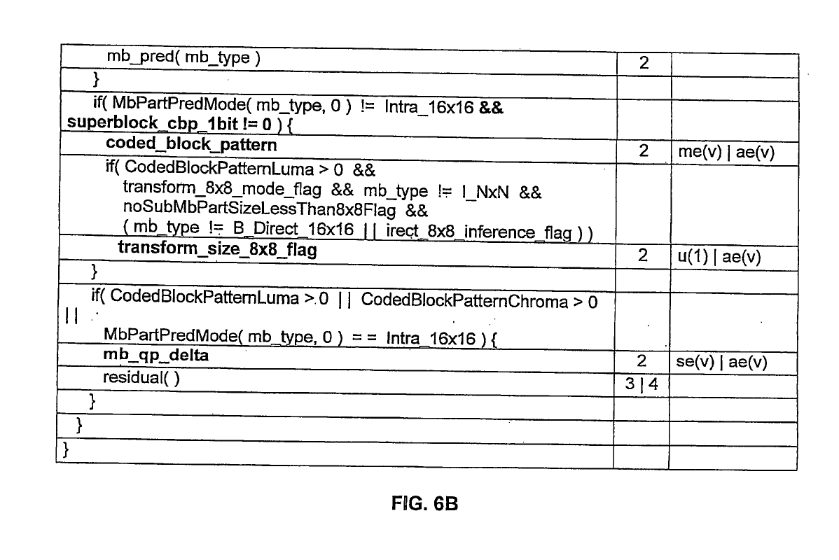

Yet additional syntaxes refer to macro-block layer semantics. For the macro-block layer, its syntax may be similar to the macroblock_layer in H.264/AVC standard with a modification to reading coded_block_pattern as illustrated in FIGS. 6A and 6B.

The semantics of a coded_block_pattern may be defined as follows. Coded_block_pattern may specify which of the six 8×8 blocks—luma and chroma—may contain non-zero transform coefficient levels. For macroblocks with prediction mode not equal to Intra_{—}16×16, the coded_block_pattern is included in the bitstream and the variables CodedBlockPatternLuma and CodedBlockPatternChroma may be derived as follows.

CodedBlockPatternLuma=coded_block_pattern % 16

CodedBlockPatternChroma=coded_block_pattern/16

When the coded_block_pattern is present, the CodedBlockPatternLuma may specify, for each of the four 8×8 luma blocks of the macroblock, one of the following cases. First, that all transform coefficient levels of the four 4×4 luma blocks in the 8×8 luma block are equal to zero. Second, that one or more transform coefficient levels of one or more of the 4×4 luma blocks in the 8×8 luma block are non-zero valued.

In the case of superblock, when superblock_cbp_{—}1 bit==0, the coded_block_pattern of Macroblock may be set to 0.

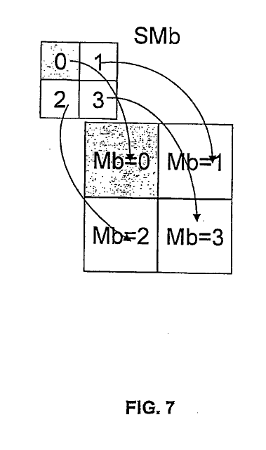

Any suitable mapping process from the super-block to the macro-block may be used. Referring to FIG. 7, a pseudo code to extract_and_save_superblock_info and copy_macroblock_info_from_superblock referred in the syntax is illustrated.

extract_and_save_superblock_info ( )

{

if (superblock_flag)
{

Save a copy of current Macroblock, let's denote it as SMb
Get superblock MV predictor from neighbor MBs.
Reconstruct superblock MV by adding superblock MVD
and superblock

MV predictor

copy_macroblock_info_from_superblock(0);

}

}

copy_macroblock_info_from_superblock(N)

{

if (superblock_flag)
{

Copy mb_type, Qp, luma_transform_size_8x8_flag,
skip_flag from SMb
if (mb_type == 16x8 ∥ mb_type == 8x16)

Set current Macroblock's mb_type to 16x16

Otherwise

Keep the mb_type same as SMb
Get the MV, reference index at the Nth 8x8 block of SMB,

copy them and fill to the current 16x6 macroblock.

}

}

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for decoding video comprising:
(a) receiving a super block flag indicating a super block consisting of a plurality of smaller blocks of pixels having shared decoding information with said super block;
(b) receiving a coded block pattern flag indicating whether said super block has a residual;
(c) decoding said super block based upon said super block flag and said coded block pattern flag.

2. The method of claim 1 wherein said super block is 32×32 pixels.

3. The method of claim 2 wherein said of said smaller blocks are 16×16 pixels.

4. The method of claim 1 wherein said super block is 64×64 pixels.

5. The method of claim 1 wherein said shared decoding information includes at least one of (a) block type; (b) transform type; and (c) motion vector.

6. The method of claim 5 wherein said decoding information includes at least two of (a), (b), and (c).

7. The method of claim 6 wherein said decoding information includes at least three of (a), (b), and (c).

8. The method of claim 1 wherein said super block has a block order and said shared decoding information is included together with the first of said smaller blocks of said block order.

9. The method of claim 1 wherein said shared decoding information is not included in other ones of said smaller blocks of said super block.

10. The method of claim 1 wherein said shared decoding information includes at least one of (a) macro block skip; (b) transform size; and (c) delta quantization.

11. The method of claim 10 wherein said decoding information includes at least two of (a), (b), and (c).

12. The method of claim 11 wherein said decoding information includes at least three of (a), (b), and (c).

13. The method of claim 1 wherein said shared decoding information includes (a) block type; (b) transform type; (c) motion vector; (d) macro block skip; (e) transform size; and (f) delta quantization.

14. A method of decoding video comprising:
(a) receiving a super block consisting of a plurality of smaller blocks of pixels having shared decoding information with said super block in a bit stream of encoded said video;
(b) extracting said shared decoding information from one of said smaller blocks of pixels;
(c) applying said shared decoding information to another one of said smaller blocks of pixels of said super block;
(d) decoding said one of said smaller blocks based upon said shared decoding information;
(e) decoding said another one of said smaller blocks based upon said shared decoding information.

15. The method of claim 14 further receiving a super block flag indicating said super block.

16. The method of claim 16 further comprising receiving a coded block pattern flag indicating whether said super block has a residual.

17. The method of claim 16 further comprising decoding said super block based upon said super block flag and said coded block pattern flag.

18. The method of claim 14 wherein said super block is 32×32 pixels.

19. The method of claim 18 wherein said of said smaller blocks are 16×16 pixels.

20. The method of claim 14 wherein said super block is 64×64 pixels.

21. The method of claim 14 wherein said shared decoding information includes at least one of (a) block type; (b) transform type; and (c) motion vector.

22. The method of claim 21 wherein said decoding information includes at least two of (a), (b), and (c).

23. The method of claim 22 wherein said decoding information includes at least three of (a), (b), and (c).

24. The method of claim 14 wherein said super block has a block order and said shared decoding information is included together with the first of said smaller blocks of said block order.

25. The method of claim 14 wherein said shared decoding information is not included in other ones of said smaller blocks of said super block.

26. The method of claim 14 wherein said shared decoding information includes at least one of (a) macro block skip; (b) transform size; and (c) delta quantization.

27. The method of claim 26 wherein said decoding information includes at least two of (a), (b), and (c).

28. The method of claim 27 wherein said decoding information includes at least three of (a), (b), and (c).

29. The method of claim 14 wherein said shared decoding information includes (a) block type; (b) transform type; (c) motion vector; (d) macro block skip; (e) transform size; and (f) delta quantization.
